(19) United States
(12) Patent Application Publication
(10) Pub. No.: US 2025/0224373 A1
(43) Pub. Date: Jul. 10, 2025

(54) SOLUTION ELECTRODE GLOW DISCHARGE APPARATUS AND METHOD OF USE

(71) Applicant: 2S Water Incorporated, Edmonton (CA)

(72) Inventors: Anthony Brent Nelson, Edmonton (CA); Avro Anthony Sargeaunt Nelson, Victoria (CA); Connor Bradley Fogal, Victoria (CA); Anthea Felicity Nelson Sargeaunt, Edmonton (CA); Anders Jacques Johannes Palmgren, Victoria (CA)

(73) Assignee: 2S Water Incorporated, Edmonton, AB (CA)

(21) Appl. No.: 19/013,960

(22) Filed: Jan. 8, 2025

Related U.S. Application Data
(60) Provisional application No. 63/618,792, filed on Jan. 8, 2024.

(51) Int. Cl. G01N 27/68

(52) U.S. Cl. CPC G01N 27/68

(57) ABSTRACT

A solution electrode glow discharge (“SEGD”) apparatus comprising a pressurized housing. The apparatus SEGD may comprise an inlet to allow entry of compressed gas in the pressurized housing; an outlet opening to allow gas flow through the pressurized housing while maintaining a specific pressure; and an optical window for letting light generated from the plasma exit the apparatus. The apparatus may comprise a solid electrode and a solution electrode and be configured to produce a plasma between a solid electrode and a solution electrode. The apparatus may be configured to flow gas from outside of the pressurized housing into the inlet and through at least a region of an interior of the pressurized housing.

### CROSS-REFERENCE TO RELATED APPLICATIONS

This application claims priority to and the benefit of the filing of U.S. Provisional Patent Application No. 63/618,792, entitled “SOLUTION ELECTRODE GLOW DISCHARGE APPARATUS AND METHOD OF USE”, filed on Jan. 8, 2024, and the specification and claims thereof are incorporated herein by reference.

### BACKGROUND OF THE INVENTION

### Field of the Invention (Technical Field)

The present invention relates to the analysis of material in solution. In particular, the present invention relates to the analysis of material by solution electrode glow discharge.

### Background

Solution electrode glow discharge (“SEGD”) is used to detect the presence of metals dissolved in water. SEGD normally operates under atmospheric pressure at or around sea level (typically below 1000 m). However, at high altitude the pressure is reduced to below one atmosphere and the SEGD plasma becomes unstable. This results in plasma failures that prevent measurement and/or that result in an unreliable measurement.

### BRIEF SUMMARY OF THE INVENTION

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a flow chart showing a process for generating a glow discharge and measuring its emission spectrum, according to an embodiment of the invention;

FIG. 2 is a diagram showing a solution electrode glow discharge apparatus wherein the chamber is pressurized, according to an embodiment of the invention;

FIG. 3 is a diagram showing a solution electrode glow discharge apparatus comprising an air inlet and outlet wherein the chamber is pressurized, according to an embodiment of the invention;

FIG. 4 is a graph showing the pressure and required increase in pressure to achieve sea level pressure, according to an embodiment of the invention;

FIG. 5 is a graph showing a lithium signal as a function of air pressure, according to an embodiment of the invention;

FIG. 6 is a graph showing a lithium signal as a function of plasma gap distance, according to an embodiment of the invention; and

FIG. 7 is a graph showing a comparison of lithium signals from different electrolytes, according to an embodiment of the invention.

### DETAILED DESCRIPTION OF THE INVENTION

Embodiments of the present invention relate to a solution electrode glow discharge (“SEGD”) apparatus comprising a pressurized housing. The apparatus may comprise a solid electrode and a solution electrode and be configured to produce a plasma between a solid electrode and a solution electrode. The apparatus may comprise an inlet to allow entry of compressed gas in the pressurized housing; an outlet opening to allow gas flow through the pressurized housing while maintaining a specific pressure; and an optical window for letting light generated from the plasma to exit the apparatus. The apparatus may be configured to flow gas from outside the pressurized housing into the inlet and through at least a region of an interior of the pressurized housing. The region may be located between the optical window and a gap between the solid electrode and the solution electrode. The gas may flow out of the pressurized housing by passing through the outlet, thereby creating gas flow for removal of droplets, condensation, and/or vapor from an optical path between the plasma and the optical window. The droplets, condensation, and/or vapor may be at least in part created by vaporization of sample fluid in the plasma. The apparatus may be maintained at sea level atmospheric pressure to achieve plasma stability by pressurizing the housing.

Embodiments of the present invention also related to a method of detecting and/or analyzing material in a sample, the method comprising: passing a solution into a capillary at least partially disposed within a solution electrode; disposing at least a portion of the sample between the solution electrode and a solid electrode; applying a voltage to the sample to generate a plasma; generating light from the plasma; forming an air curtain between the plasma and an optical window; and passing the light through the optical window. The method may further comprise contacting the sample with a pressurized atmosphere. The method may further comprise disposing sample into an overflow separator. The method may further comprise detecting a metal in the sample.

The apparatus may use a base (e.g., a caustic) for the formation of the plasma. The use of a base may allow the SEGD to test high pH samples for contaminants and/or prevent the formation of toxic vapor. The apparatus may be used to measure gold in cyanide solutions.

The terms “metal” or “metals” as used herein means a compound, mixture, or substance comprising a metal atom. The term “metal” or “metals” includes, but is not limited to, metal hydroxides, metal oxides, chemicals comprising a metal atom, metal salts, elemental metals, metal ions, non-ionic metals, minerals, or a combination thereof.

The term “high-error measurement” as used herein means any measurement having associated noise or low accuracy such that it cannot be relied on as a true and correct measurement.

The terms “glow discharge” and “plasma” are used interchangeably throughout the specification and drawings.

The terms “sample” or “samples” as used herein mean any matter disposed into an SEGD apparatus.

The term “gas” as used herein means any gas or combination of gasses including, but not limited to, air, oxygen, nitrogen, argon, neon, helium, krypton, xenon, or a combination thereof.

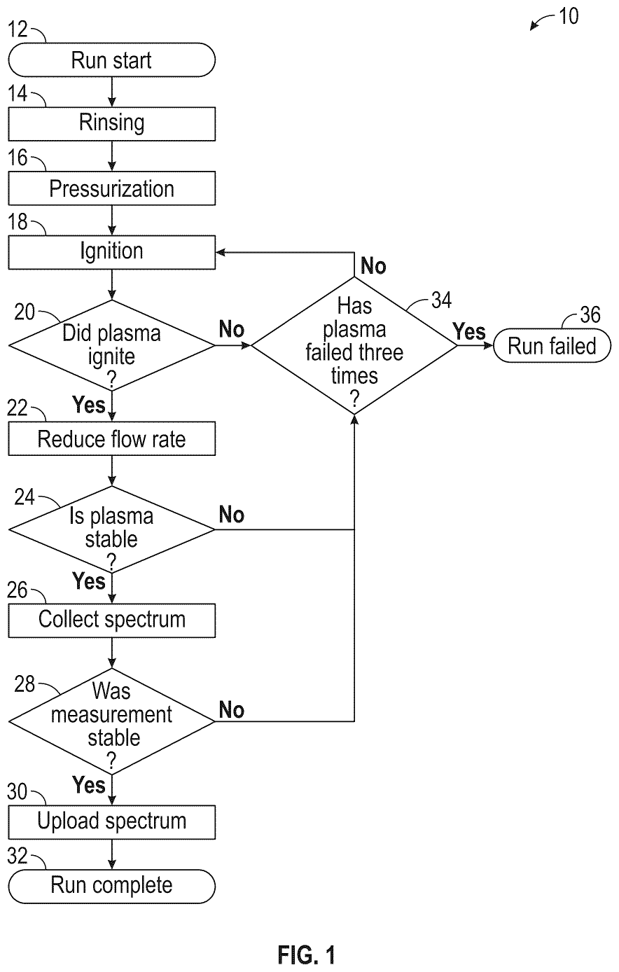

Turning now to the figures, FIG. 1 shows flow chart 10 showing a process for generating a glow discharge and measuring an atomic emission spectrum using an SEGD apparatus and associated operational software. The SEGD apparatus is engaged by run start program 12, and the SEGD apparatus is cleaned in rinsing step 14 and a sample is added to the SEGD apparatus. The SEGD apparatus subsequently undergoes pressurization 16. The pressure may be adjusted to any pressure. Optionally pressurization 16 may occur at any time before an emission spectrum is collected, The SEGD apparatus undergoes ignition step 18 to convert the sample into plasma. It subsequently determines if plasma successfully ignites 20. Flow rate of sample 22 is reduced if plasma successfully ignites 20 and stability of plasma 24 is evaluated. Emission spectrum 26 is collected if the plasma remains stable. Measurement stability 28 is evaluated to determine if excessive noise creates a high-error measurement. A stable atomic emission spectrum measurement is uploaded 30 to a database. The database may be an internal hard drive, external hard drive, server, CD-ROM, or a combination thereof. The database may reside locally, remotely or in a cloud server. The SEGD operational software indicates run complete 32 once the emission spectrum is successfully uploaded. If plasma 24 fails to successfully ignite 20, assessment 34 is performed. Assessment 34 is also performed if stability of plasma 24 or measurement stability 28 is not achieved. Assessment 34 is the determination if plasma 24 has failed to ignite multiple times (e.g., three separate times). Ignition step 18 is performed if the plasma has not failed to ignite multiple separate times. The SEGD apparatus software indicates run failed 36 if plasma 24 has failed to ignite multiple separate times.

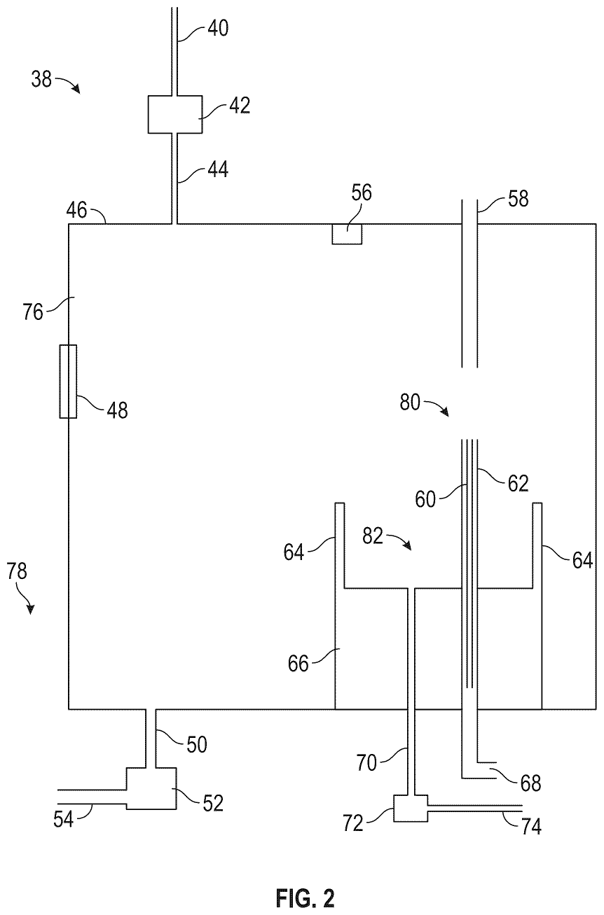

FIG. 2 shows SEGD apparatus 38 comprising pressurized air inlet 40, pressure regulator 42, pressurized air conduit 44, housing 46, optical window 48, pressurized air outlet conduit 50, air outflow regulator valve 52, pressure air outlet 54, pressure sensor 56, solid electrode 58, capillary tube 60, solution electrode 62, reservoir wall 64, reservoir body 66, sample inlet 68, overflow conduit 70, overflow separator 72, and overflow outlet 74. Optionally, pressure regulator 42 and air outflow regulator valve 52 may be interchanged. Housing 46 is configured to be air-tight and capable of maintaining a pressurized environment in housing interior 76 relative to the external region 78. Housing 46 is pressurized by flowing pressurized air into pressurized air conduit 44. The pressurized air is regulated by pressure regulator 42, passes through pressurized air conduit 44 and enters housing interior 76. The pressure in housing interior 76 is monitored by pressure sensor 56. Pressurized air flows out of housing interior 76 through air outlet conduit 50. Pressurized air exits air outlet conduit 50, enters air outflow regulator valve 52, and passes out of SEGD apparatus 38 through pressure air outlet 54. A sample enters SEGD apparatus 38 through sample inlet 68 and enters capillary tube 60. Capillary tube 60 is disposed within solution electrode 62. An electric potential is applied between the solid electrode 58 and solution electrode 62 forming a glow discharge across gap 80. The sample flows out of capillary tube 60 and enters reservoir cavity 82 formed by reservoir wall 64 and reservoir body 66. The overflow sample flows out of reservoir cavity 82 and into overflow conduit 70. The overflow sample exits overflow conduit 70, passes into overflow separator 72, and exits SEGD apparatus 38 through overflow outlet 74.

SEGD apparatus 38 generates plasma in gap 80 between solid electrode 58 and solution electrode 62. Solution electrode 62 is a cathode if solid electrode 58 is an anode. Solution electrode 62 is an anode if solid electrode 58 is a cathode. Solution electrode 62 is in communication with sample inlet 68, such that solution electrode 62 is in communication with sample inlet 68. This causes the sample to become electrically charged by the anode. The sample may comprise any or a plurality of materials including, but not limited to, contaminants, solutes, or any other material, or a combination thereof. The sample is released into gap 80 between solid electrodes 58 and solution electrode 62 and may overflow outside gap 80 and pool in reservoir cavity 82. A glow discharge forms between solid electrode 58 and solution electrode 62. The sample may be converted into plasma upon exit from capillary tube 60. Spectroscopic analysis of the emitted light may be used to determine which elements are present in the sample. Emitted light is viewed through optical window 48.

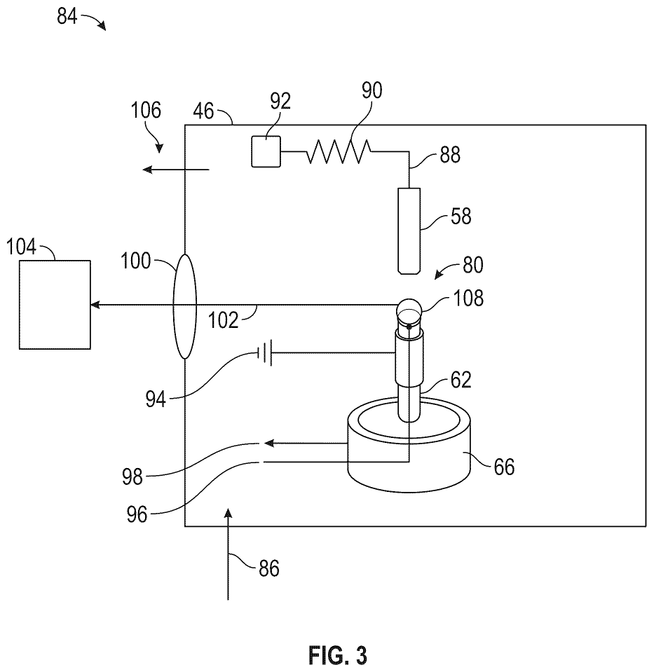

FIG. 3 shows solution electrode glow discharge apparatus 84 comprising air flow path 86. Glow discharge apparatus 84 comprises housing 46, solid electrode 58, solution electrode 62 comprising a capillary tube (not shown), reservoir body 66, and electrical conduit 88, resistor 90, and power supply 92. Solid electrode 58, solution electrode 62, and reservoir body 66 are disposed within housing 46. A capillary tube is disposed within solution electrode 62. Electrical conduit 88 allows electron flow between solid electrode 58 and solution electrode 62. Electrical conduit 86 is in communication with resistor 90 and power supply 92. Optionally, power supply 92 may be a high voltage power supply. Solid electrode 58 is grounded 94. Sample 96 is introduced into gap 80 via solution electrode 62 to generate plasma 108. Sample 96 that is not converted to plasma 108 exits reservoir body 66 as waste 98. Plasma 108 is observed and/or analyzed through lens 100 by analytical device (e.g., a spectrometer) 104. Lens 100 focuses light 102 into a fiber optic cable which may carry light 102 through housing 46 to analytical device 104. Housing 46 is pressurized by air entering housing 46 as indicated by air flow path 86. Pressurized air exits housing 46 as indicated by air path 106. Air flow paths 86 and 106 also form an air curtain between lens 100 and plasma 108 to allow for unobstructed viewing and/or analysis of plasma 108 through lens 100 by removing droplets, vapor, and/or condensation. Optionally, pressurized air may enter and exit housing 46 may enter and/or exit through any inlet and/or outlet between lens 100 and plasma 108.

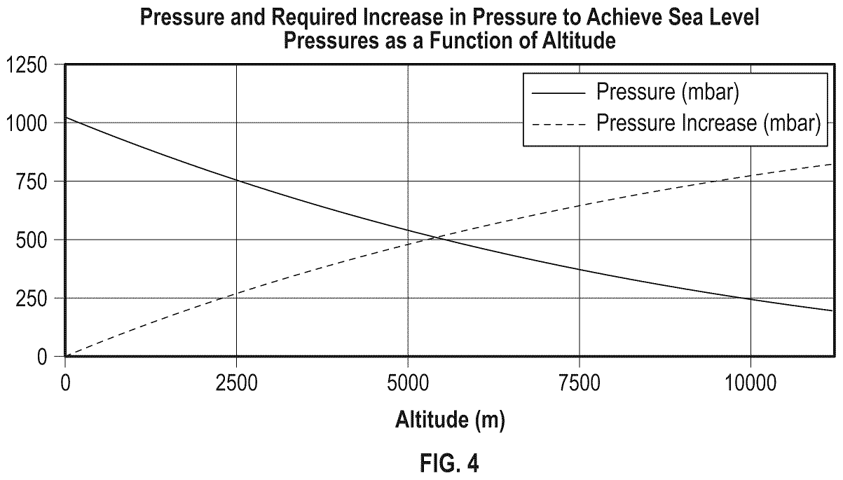

FIG. 4 shows the pressure and required increase in pressure to achieve sea level pressure. At an altitude of zero meters (“m”), e.g., sea level, the pressure is about 1,000 hectoPascals (“hPa”) and the pressure increase required to achieve sea level pressure is 0 hPa. At an altitude of 5,000 m, the pressure is about 500 hPa and the pressure increase required to achieve sea level pressure is about 500 hPa. At an altitude of 10,000 m, the pressure is about 250 hPa and the pressure required to achieve sea level pressure is about 750 hPa.

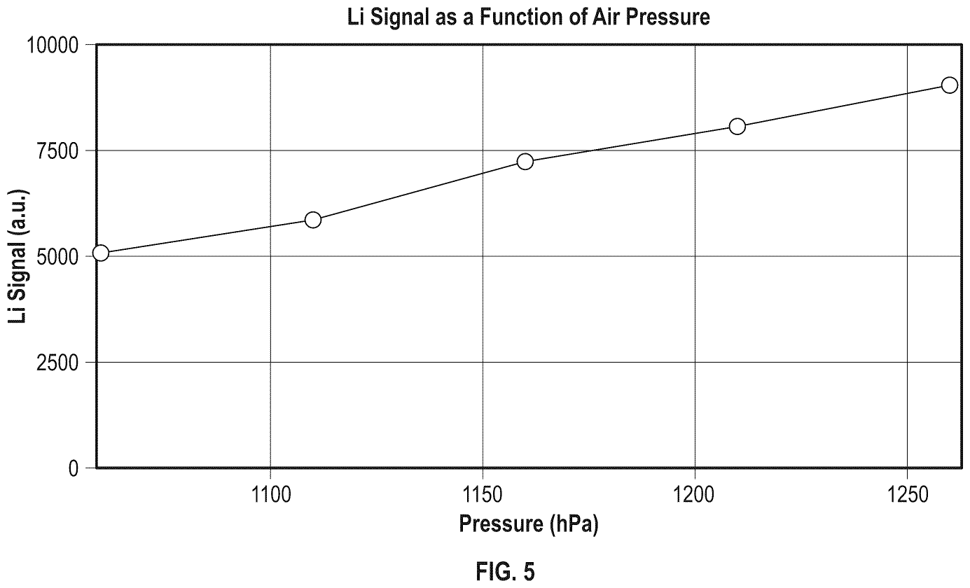

FIG. 5 shows a lithium signal as a function of air pressure at a constant plasma gap distance. Lithium signal increases as air pressure increases. Lithium signal increases from about 5,000 arbitrary units (“a. u.”) at about 0 hPa to about 8,750 a. u. at about 1,250 hPa. One atmosphere is approximately 1,013.25 hPa.

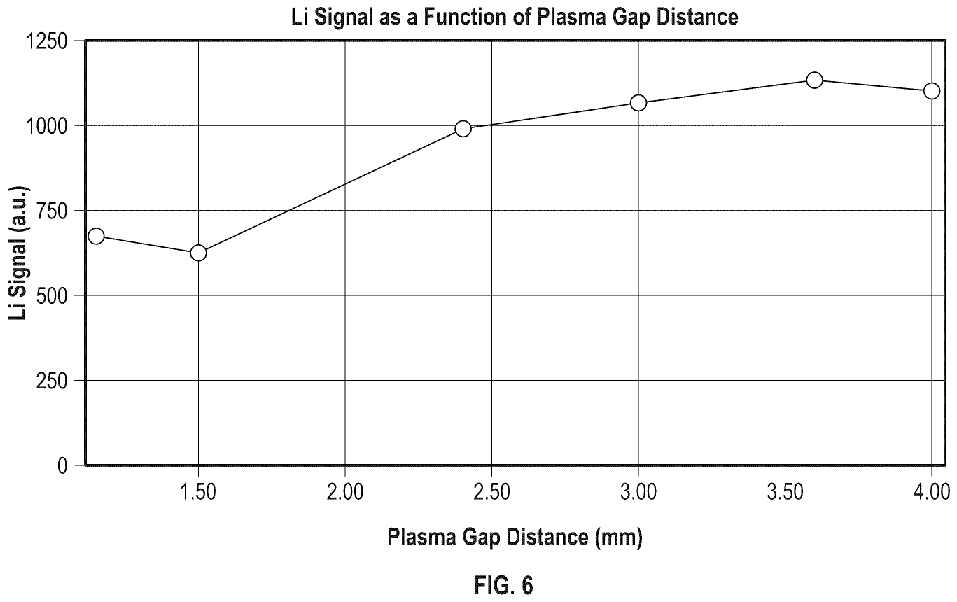

FIG. 6 shows a lithium signal as a function of plasma gap distance at a constant air pressure. Lithium signal increases as band gap distance increases over 1.5 millimeters (“mm”).

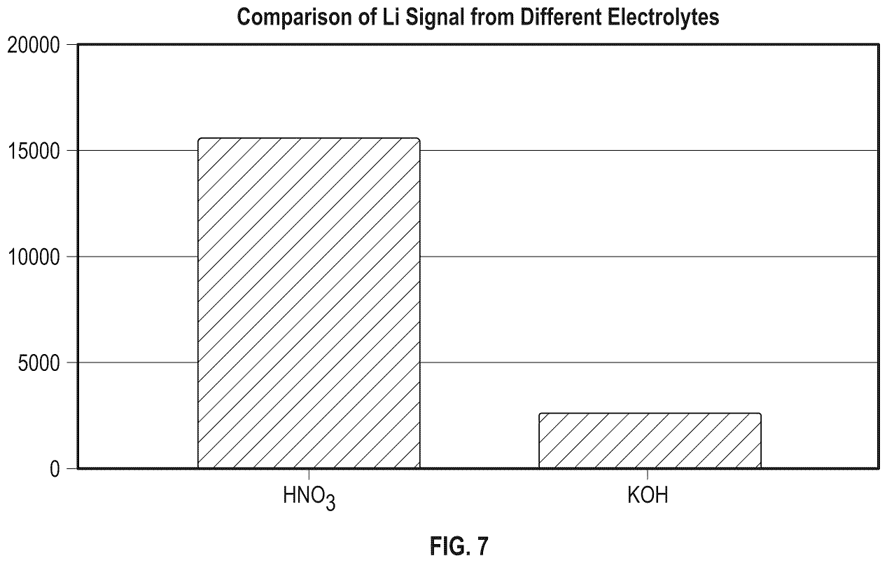

FIG. 7 shows a comparison of lithium signals from different electrolytes at a constant pressure and plasma gap distance.

The apparatus may comprise a housing that is capable of being pressurized. The pressurized housing may be configured to receive a compressed gas to increase the internal pressure of the housing. The housing may be pressurized to at least about 10 hPa, about 10 hPa to about 10000 hPa, about 50 hPa to about 9000 hPa, about 100 hPa to about 8000 hPa, about 500 hPa to about 7000 hPa, about 750 hPa to about 6000 hPa, about 1000 hPa to about 5000 hPa, about 1500 hPa to about 4000 hPa, about 2000 hPa to about 3000 hPa, or about 10,000 hPa.

The housing may be pressurized to a value above sea level to reduce the noise and increase signal in a measurement. Reducing the noise level in the measurement may improve the sensitivity of the measurement and achieve a lower minimum detection limit.

The apparatus may comprise a base and/or acid to provide conductivity allowing the formation of the plasma.

The sample may comprise a solution. The solution may comprise a salt, electrolyte, a caustic solution, an acid, or a combination thereof. The solution may comprise a brine. The brine may comprise a salt. The solution may provide conductivity to allow the formation of plasma. The acid may include, but is not limited to, nitric acid. The caustic solution may include, but is not limited to, cesium hydroxide, rubidium hydroxide, lithium hydroxide, potassium hydroxide, sodium hydroxide, or a combination thereof.

The sample may comprise any element or compounds including, but not limited to, gold, silver, a platinum group metal, cyanide, arsenic, or a combination thereof.

The apparatus may comprise a gas. The gas may include, but is not limited to, air, oxygen, nitrogen, argon, neon, helium, krypton, xenon, radon, carbon dioxide, carbon monoxide, or a combination thereof.

The apparatus may comprise a solid electrode. The solid electrode may include, but is not limited to, tungsten, copper, iron, aluminum, carbon, gold, silver, platinum titanium, molybdenum, or a combination thereof. The solid electrode may be disposed above the surface of a capillary tube. The solid electrode may be disposed at least about 0.5 mm, about 0.5 mm to about 5 mm, about 1 mm to about 4.5 mm, about 1.5 mm to about 4 mm, about 2 mm to about 3.5 mm, about 2.5 mm to about 3 mm, or about 5 mm. The capillary tube may comprise glass, borosilicate, or any other material or a combination thereof. The capillary may comprise an inner diameter of at least about 0.1 mm, about 0.1 mm to about 0.5 mm, about 0.2 mm to about 0.4 mm, or about 0.5 mm. The system may further comprise a grounded steel (or other material) tube. The tube may be at least partially disposed around the capillary.

The apparatus may comprise a power supply. The power supply may generate a constant current of at least about 30 milliamperes (“mA”), about 30 mA to about 500 mA, about 75 mA to about 450 mA, about 100 mA to about 400 mA, about 125 mA to about 350 mA, about 150 mA to about 300 mA, about 175 mA to about 250 mA, or about 500 mA maintain a discharge. The power supply may generate a voltage of at least about 500 volts (“V”), about 500 V to about 4000 V, about 1000 V to about 3500 V, about 1500 V to about 3000 V, about 2000 V to about 2500 V, or about 4000 V. The power supply may be configured to provide a constant current. The voltage may vary based on the contaminants disposed within the source water when the plasma is held to a given amperage.

The apparatus may comprise a resistor. The resistor may be a ballast or load resistor and may have a resistance of at least about 1000 ohms (“Ω”), about 1000Ω to about 3000Ω, about 1500Ω to about 2500Ω, about 1750Ω to about 2250Ω, or about 3000Ω. The resistor may be disposed in the circuit between a cathode and an anode and may stabilize the current and/or voltage to prevent electric arcs.

The apparatus may comprise one or more pumps to flow sample into a solution electrode. The pump may produce a flow rate of at least about 30 microliters per minute (“μL/minute”), about 30 μL/minute to about 6000 μL/minute, about 50 μL/minute to about 5500 μL/minute, about 100 μL/minute to about 5000 μL/minute, about 300 μL/minute to about 4500 μL/minute, about 500 μL/minute to about 4000 μL/minute, about 750 μL/minute to about 3500 μL/minute, about 1000 μL/minute to about 3000 μL/minute, or about 6000 μL/minute. The pump may introduce but is not limited to an acid, deionized water, a standard, a surfactant, or a combination thereof into the apparatus. The apparatus may comprise a mixing chamber that mixes solutions before the sample and/or mixed sample and reagent is flowed to the plasma chamber.

The apparatus may comprise an optical window. The optical window may include, but is not limited to, a lens, a glass window, or a combination thereof. The lens may include, but is not limited to, a single-fused lens, a bi-convex lens, or a combination thereof, and may comprise silica. The lens may comprise a focal length of at least about 20 mm, about 20 mm to about 50 mm, about 25 mm to about 45 mm, about 30 mm to about 40 mm, or about 50 mm. The lens may comprise a diameter of at least about 15 mm, about 15 mm to about 35 mm, about 20 mm to about 30 mm, or about 35 mm. The optical window may form an optical path. The optical path may lead to a fiber optic input, e.g., a fiber optic cable. The fiber optic input may be disposed in a manifold. The manifold may be configured to allow for three axes of movement.

The apparatus may comprise a controlled gas flow that may remove at least a portion of the vapor, condensation, and/or droplets created by vaporization of the sample in the plasma from an optical path between the plasma and the optical window. The gas flow may be generated by a gas compressor and the pressurized housing.

The apparatus may comprise fiber optic cable in communication with the manifold. The output of the fiber optic cable may be in communication with a spectrometer. The spectrometer may comprise a grating of at least about 400 lines per millimeter (“lines/mm”), about 400 lines/mm to about 800 lines/mm, about 500 lines/mm to about 700 lines/mm, or about 800 lines/mm. The spectrometer may comprise a bandwidth of at least about 150 nanometers (“nm”), about 150 nm to about 1,000 nm, about 200 nm to about 2,000 nm, about 250 nm to about 2,500 nm, about 300 nm to about 3,000 nm, about 350 nm to about 3,500 nm, about 400 nm to about 4,000 nm, about 450 nm to about 4,500 nm, or about 5,000 nm. The spectrometer may comprise a slit of at least about 15 micrometers (“μm”), about 15 μm to about 40 μm, about 20 μm to about 35 μm, about 25 μm to about 30 μm, or about 45 μm.

The apparatus may be pressurized. The apparatus may be pressurized by a compressor. The apparatus may comprise a gas compressor, filter, and/or regulator in communication with a housing. The apparatus may comprise a barometer to measure air pressure. The apparatus may comprise a flow meter and/or valve in communication with a gas outlet. The flow meter and/or needle valve may control the gas flow and/or allow for pressurization without condensation forming on the lens.

The apparatus may be pressurized to operate at any altitude. The altitude may be at least about −40,000 meters above mean sea level (“mamsl”), about −35,000 mamsl to about 30,000 mamsl, about −30,000 mamsl to about 25,000 mamsl, about −25,000 mamsl to about 20,000 mamsl, about −20,000 mamsl to about 15,000 mamsl, about −10,000 mamsl to about 12,000 mamsl, about 0 mamsl to about 10,000 mamsl, about −500 mamsl to about 7,500 mamsl, about 1,000 mamsl to about 5,000 mamsl, or about 30,000 mamsl.

The method may comprise introducing discharged sample into a plasma. The plasma may be ignited at a voltage of at least about 500 V, about 500 V to about 2500 V, about 1000 V to about 3000 V, about 1500 V to about 3500 V, or about 4000 V. Optionally, ignition may be achieved by reducing the distance of the plasma gap until ignition occurs.

The method may comprise an anodic voltage applied to a solid electrode (anode) while overflowing sample completes the circuit when it comes into contact with the grounded conductive tube.

The method may comprise use of nitric acid (“HNO₃”) as an electrolyte results in a greater lithium signal than use of potassium hydroxide (“KOH”). HNO₃ results in a signal of about 15,000 a. u. whereas KOH results in a signal of about 2,500 a. u. Another acid or base may be selected depending on the chemistry of source waters being analyzed.

Embodiments of the present invention provide a technology-based solution that overcomes existing problems with the current state of the art in a technical way to satisfy an existing problem for scientists and technologists. Embodiments of the present invention achieve important benefits over the current state of the art, such as measurements at high altitude. Some of the unconventional steps of embodiments of the present invention include a pressurized chamber and viewing window.

### INDUSTRIAL APPLICABILITY

The invention is further illustrated by the following non-limiting examples.

### EXAMPLE 1

A test was performed using an SEGD. A pointed tungsten rod was placed 3 mm above the surface of a 0.3 mm inner diameter borosilicate glass capillary tube. A grounded stainless-steel tube was disposed around the capillary. A high-voltage power supply was used to apply a voltage to the tungsten rod, initiating a current between the tungsten rod and solution electrode and/or capillary tube. The high voltage power supply used a constant current to maintain the discharge. A solution was introduced into the system through the glass capillary. This overflowed into contact with the grounded conductive tube. A voltage was applied to the tungsten electrode while the grounded stainless-steel tube completed the circuit when the overflowing solution came into contact with the grounded metal generating a glow discharge. The cathode alignment was done using a platform which allowed for movement in three axes with respect to the capillary. The capillary was placed in an overflow reservoir which collected and removed the overflowing sample. The ballast resistor was placed in the circuit before the anode to stabilize the current and voltage to prevent arcs. A pump supplied the solution to the capillary.

The voltage was set at 1500 V and an initial flow rate of 4200 μL/min was used to ignite the discharge. After ignition, the flow rate was reduced to 4000 μL/min and the voltage stabilized at around 900 V. The change in voltage was watched during an initial stabilization phase to determine stability. The second gradient of the voltage over time was used to determine stability. The plasma was considered stable and went into the measurement phase if the second gradient reached a threshold. The measurement failed and was redone and the plasma was deemed unstable if the second gradient failed to remain stable or if the plasma went out. The plasma was viewed through a single fused silica bi-convex lens. The optical path then led to a fiber optic input which was in a manifold allowing for three axis movement. The output of the fiber optic cable led to a spectrometer with a grating of 600 lines/mm, a bandwidth of 190 nm to 746 nm, and a 25 μm slit.

A stainless-steel chamber was built to pressure this system. The stainless-steel chamber was linked to an air compressor, filter, and a regulator. The pressure was measured using an electronic barometer. An air flow meter and valve were used to control the airflow and allow for pressurization without condensation forming on the lens.

The preceding examples can be repeated with similar success by substituting the generically or specifically described reactants and/or operating conditions of this invention for those used in the preceding examples.

Note that in the specification and claims, “about” or “approximately” means within twenty percent (20%) of the numerical amount cited. The terms, “a”, “an”, “the”, and “said” mean “one or more” unless context explicitly dictates otherwise.

Although the invention has been described in detail with particular reference to these embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A solution electrode glow discharge apparatus, the apparatus comprising:
a housing capable of being pressurized comprising a gas inlet and a gas outlet;
a solid electrode;
a solution electrode comprising a capillary tube;
a gap between said solid electrode and said solution electrode; and
an overflow separator.

2. The solution electrode glow discharge apparatus of claim 1 further comprising an optical window.

3. The solution electrode glow discharge apparatus of claim 2 wherein said optical window comprises a glass window.

4. The solution electrode glow discharge apparatus of claim 2 wherein said optical window comprises a lens.

5. The solution electrode glow discharge apparatus of claim 2 further comprising a gas curtain between said gap and said optical window.

6. The solution electrode glow discharge apparatus of claim 1 wherein said housing is pressurized by a gas.

7. The solution electrode glow discharge apparatus of claim 6 wherein said gas comprises air.

8. The solution electrode glow discharge apparatus of claim 1 wherein said solid electrode comprises tungsten.

9. The solution electrode glow discharge apparatus of claim 1 wherein said solid electrode comprises copper.

10. The solution electrode glow discharge apparatus of claim 1 further comprising an inlet for introducing a solution at least partially disposed within said solution electrode.

11. The solution electrode glow discharge apparatus of claim 10 wherein the solution comprises a base.

12. The solution electrode glow discharge apparatus of claim 10 wherein the solution comprises an acid.

13. The solution electrode glow discharge apparatus of claim 10 wherein the solution comprises an electrolyte.

14. The solution electrode glow discharge apparatus of claim 1 wherein said solid electrode is at least partially disposed across from a surface of said capillary tube.

15. The solution electrode glow discharge apparatus of claim 1 further comprising a high voltage power supply.

16. A method of detecting material in a sample, the method comprising:
passing a solution into a capillary at least partially disposed within a solution electrode;
disposing at least a portion of the sample between the solution electrode and a solid electrode;
applying a voltage to the sample to generate a plasma;
generating a light from the plasma;
forming a gas curtain between the plasma and an optical window; and
passing the light through the optical window.

17. The method of claim 16 further comprising discharging the sample into the plasma.

18. The method of claim 16 further comprising igniting the plasma at a voltage of at least about 500 V to about 4000 V.

19. The method of claim 16 further comprising applying an anodic voltage to the solid electrode.

20. The method of claim 16 further comprising detecting the material under a pressurized atmosphere.
